(19) United States
(12) Patent Application Publication
(10) Pub. No.: US 2009/0227240 A1
(43) Pub. Date: Sep. 10, 2009

(54) SYSTEMS AND METHODS FOR PARKING ENFORCEMENT

(75) Inventor: Rodney L. Sheets, Salt Lake City, UT (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: VELOSUM, INC., Sandy, UT (US)

(21) Appl. No.: 12/399,790

(22) Filed: Mar. 6, 2009

Related U.S. Application Data
(60) Provisional application No. 61/034,877, filed on Mar. 7, 2008.

(51) Int. Cl. H04M 3/42; G06K 11/06; G06F 17/30

(52) U.S. Cl. 455/414.2; 178/19.01; 707/100; 707/3; 707/E17.014

(57) ABSTRACT

Disclosed herein are systems and methods that may be utilized to determine parking zone time limit violations, and which may also be utilized to issue parking citations. A system according to the present disclosure may incorporate a digital pen, and mobile communication device, and one or more paper forms. When a chalking form is used, the system creates an electronic chalking record, indicating that a particular vehicle was parked in a location at a specific time. The electronic chalking record may be stored in a chalking database. Later, the database may be queried to determine whether a citation for a parking zone time limit violation should be issued.

### RELATED APPLICATION

This application claims the benefit under 35 U.S.C. § 119(e) of U.S. Provisional Application No. 61/034,877, filed Mar. 7, 2008, which is hereby incorporated by reference herein in its entirety.

### COPYRIGHT NOTICE

© 2009 Velosum, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71 (d).

### TECHNICAL FIELD

This disclosure relates to systems and methods for parking enforcement.

### BRIEF DESCRIPTION OF THE DRAWINGS

FIG. 1 is a block diagram of a system for processing data received from a digital pen.

FIG. 2 is a block diagram of a data structure for a stroke collection file.

FIG. 3 is a block diagram of a web server usable by the system shown in FIG. 1 for processing data received from a digital pen, recognizing handwriting in a form field written using the digital pen, and determining when it is appropriate to issue a citation to a vehicle.

FIG. 4 is a flow chart a method for processing information in the web server shown in FIG. 3.

FIG. 5 graphically illustrates an example chalking form that may be used in one embodiment of the parking enforcement systems and methods disclosed herein.

FIG. 6 graphically illustrates an example parking ticket that may be used in one embodiment of the parking enforcement systems and methods disclosed herein.

### DETAILED DESCRIPTION OF PREFERRED EMBODIMENTS

In many municipalities parking in a specific area may be limited to a specific amount of time. If a vehicle has not been moved a distance established by the municipality within the set amount of time, a parking zone time limit violation occurs. The term “chalking” refers to the practice of marking a vehicle's tires to determine parking zone time limit violations. In the past, chalking has been done by making a mark with chalk on a vehicle's tire and recording the time of the mark. At some time after the allowable length of time for parking, a parking enforcement officer (“PEO”) who marked the tires of vehicles in a particular area would then return to the area at some later time to determine whether the chalked vehicles were still parked in the zone. If any vehicles having the chalk mark made by the PEO remain in the zone, the PEO could then issue a citation to such vehicles.

Disclosed herein are systems and methods that may be utilized to determine parking zone time limit violations, and which may also be utilized to issue parking citations. A system according to the present disclosure may incorporate a digital pen, and mobile communication device, and one or more paper forms. When a chalking form is used, the system creates an electronic chalking record, indicating that a particular vehicle was parked in a location at a specific time. The electronic chalking record may be stored in a chalking database. Later, the same officer or a different officer may again pass by the location, may query the chalking database, and may determine whether a citation for a parking zone time limit violation should be issued.

A PEO may write on a paper form using a digital pen that both marks the form and electronically records the marks in relation to various form fields. Thus, pen strokes made on the paper form may be automatically determined and an electronic image of the paper form may be generated that includes the pen strokes. Digital pens usable with the disclosure herein include, for example, a digital pen available from Anoto AB of Stockholm, Sweden (also referred to herein as an “Anoto®-type pen”), a digital pen available from Hitachi Maxell Ltd. of Tokyo, Japan, or a digital pen available from Logitech Inc. of Fremont, Calif., USA.

In certain embodiments, paper forms may be identified using a form dot pattern (FDP). The form dot pattern may both allow a camera to determine the position of the pen with respect to the paper form, and to determine the type of paper form being used. Accordingly, a system as disclosed herein may provide a single system for allowing a PEO to both write citations and perform chalking, thus reducing the amount of equipment a PEO must carry, and simplifying the task of training PEOs to use the system.

In certain embodiments, when a chalking record is received the parking enforcement system may also query other databases to determine whether a citation should be issued for violations not related to parking zone time limits. For example, the system may prompt a PEO to issue a citation to a car with an expired registration, may prompt a PEO to take action when a stolen vehicle is chalked, or may prompt a PEO to have a vehicle immobilized if a certain number of unpaid parking citations are associated with the vehicle. Of course, other criteria for alerting a PEO may also be implemented by the system.

In certain embodiments, a Global Positioning System (GPS) system may be included so as to automate the process of recording the position of chalked vehicles. Still other embodiments may rely on RFID tags to automate the process of determining the location of parked vehicles. RFID tags may be placed at certain intervals throughout a parking zone (e.g. on parking meter). Each RFID tag may be able to communicate information regarding its position to an RFID tag reader. An RFID tag reader may be used in connection with the system to determine the location of a vehicle based on an RFID tag located in proximity to the vehicle. In certain embodiments, parking zone time limit parameters may be automatically determined based on location. In embodiments utilizing a GPS receiver or an RFID tag reader, parking zone time limits of a particular area may be determined with reference to a database that correlates the particular location with the parking zone time limit in that area.

In yet other embodiments, a photograph of a vehicle's license plate may be taken, and character recognizing software may extract the license plate from the photograph to further automate the process of chalking. In such embodiments, the photograph may also be utilized to provide proof that a particular vehicle was parked in a location at a particular time. In embodiments incorporating a GPS system and photographic systems, the process of chalking may simply consist of taking a picture of each license plate. The system may then determine the time, location, parking zone time limit, and license plate of the vehicle.

In previous chalking systems, a PEO who made a chalk mark on a particular vehicle would be the only PEO with knowledge of the time the mark was made. Accordingly, other PEOs could not easily issue tickets based on the chalking of another officer. The systems and methods disclosed herein allow other officers to have access to chalking records. Further, supervisors of PEOs may be able to track the productivity of each PEO based on statistics, such as number of chalking records, number of citations, and the like. The system may record and store data that may be valuable information. Traffic planners may utilize the data to create data trends within certain cities with similar demographics. The data may also help to increase revenue by being able to identify patterns (e.g. areas having a high incidence of parking violations).

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a machine-readable medium having stored thereon instructions that may be used to program a computer (or other electronic device) to perform processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

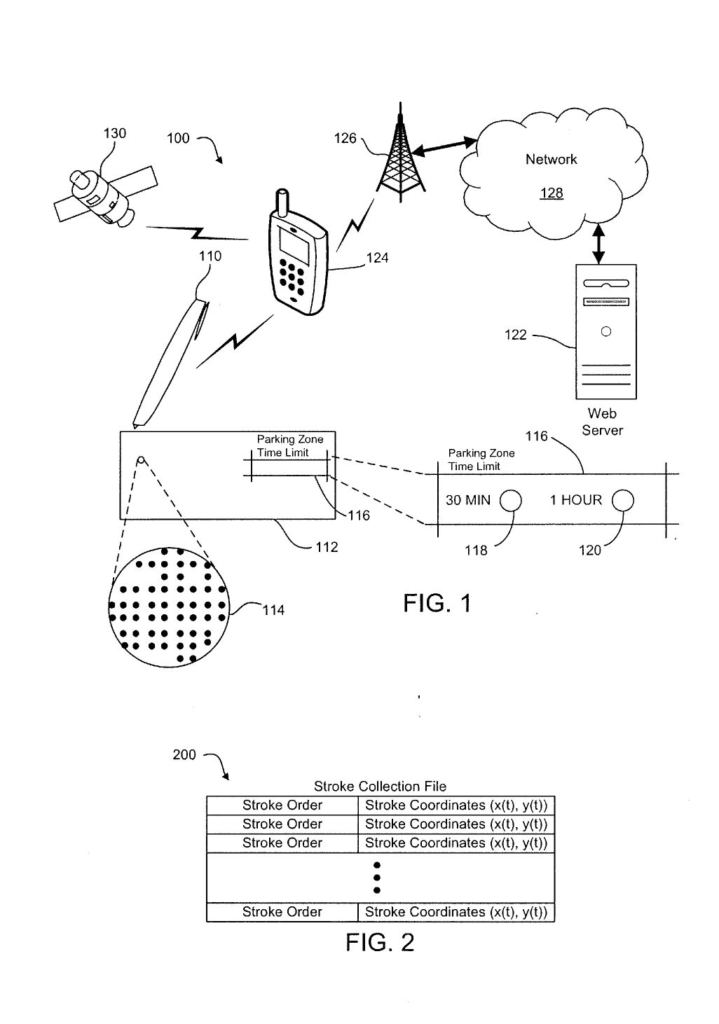

FIG. 1 is a block diagram of one embodiment of a system 100 for processing data received from a digital pen 110. The digital pen 110 is configured to write on a paper form 112 and to electronically capture pen strokes in relation to a position-coding pattern 114 on a writing surface of the form 112. As discussed above, the digital pen 110 may include an Anoto®-type pen. Thus, although not shown, the digital pen 110 may include a ball point tip, an ink cartridge, a camera with a lens that is directed toward the ball point tip, a pressure sensitive sensor that activates when pressure is applied to the ball point tip, a processor, a memory device, a communication device, and a power source. Other digital pens may use other technologies to determine the position of the pen with respect to the paper, including an ultrasound and infrared communication system, or a tablet-based input. One having skill in the art will recognize from the disclosure herein that other types of digital pens known in the art may also be used.

In one embodiment, a PEO may use the digital pen to make pen strokes (e.g., in ink) on the paper form 112. The digital pen 110 determines the location of the pen strokes on the form 112 relative to the position-coding pattern 114 by analyzing the position-coding pattern 114 as pressure is applied to the ball point tip. Thus, each pen stroke is associated with a series of coordinates (x(t), y(t)) in, for example, a Cartesian coordinate system defined by the position-coding pattern 114. Here, x(t) corresponds to a unique location in the position-coding pattern 114 along an x-axis at a particular time during the stroke. Similarly, y(t) corresponds to a unique location in the position-coding pattern 114 along a y-axis at a particular time during the stroke.

In one embodiment, the form 112 includes one or more predetermined form fields 116 that a PEO may mark using the digital pen 110 to make a particular selection. Form fields may be specific to the type of form 112 being used. For example, a chalking form may include a field for recording a parking zone time limit. In the example shown in FIG. 1, the field 116 is enlarged to illustrate that a PEO may record the time limit of a particular parking zone. Where the form is a citation form, other fields may be present, such as the type of violation, the make of the vehicle, the location of the offense, etc. An artisan will recognize from the disclosure herein that a wide variety of types of data may be recorded utilizing the principles disclosed herein.

The field 116, and other fields as appropriate, may be preprinted on the form 112 at predetermined locations with respect to the position-coding pattern 114. Thus, the position of a pen stroke relative to the position-coding pattern 114 may be used to determine if the PEO has marked a location within an area defined by the field 116.

The position-coding pattern 114 may be unique to a particular type of form. Accordingly, the digital pen 110 may be able to determine both the type of form and the position of the pen strokes on the form 112 utilizing the position-coding pattern 114. Such functionality may allow the system to be used to fill out chalking forms, parking citations, moving violation citations, and a variety of other forms.

Data for each stroke collected by the digital pen 110 may be stored in a stroke collection file. The stroke collection file may be communicated to a web server 122 through a mobile communication device, such as, for example, a PEO's cellular phone 124, a wireless communication system 126, and a network 128. The network 128 may be the Internet, a local area network (LAN), a metropolitan area network (MAN), a wide area network (WAN), or other type of network. The network 128 may comprise a cellular phone network, a Wi-Fi network based on an IEEE 802.11 standard, an Evolution-Data Optimized (EVDO) network, a G3 network, or any other communications protocol capable of communicatively coupling the mobile communication device 124 with the web server 122.

The web server 122 includes a processor for performing software instructions on the data received from the digital pen 110, as described herein. In addition, or in another embodiment, the cellular phone 124 may also perform part or all of the processing on the data received from the digital pen 110. In one embodiment, the digital pen 110 transmits data to the cellular phone 124 using a wireless data communication protocol, such as Bluetooth®. Other wireless data communications protocols may also be utilized, such as IrDA, ultra-wide band, ZigBee, and the like. In addition, or in other embodiments, the data may be retrieved from the digital pen 110 using a cable or docking station.

A GPS receiver may be utilized to automate the process of recording the position of chalked vehicles. A GPS receiver may be included in cellular phone 124, or it may be a discrete component that is communicatively connected to mobile device 124, for example using Bluetooth®. The GPS receiver may be in communication with a plurality of GPS satellites 130. Based on information received from the GPS satellites 130, the GPS receiver may determine the location of the mobile device 124, and thus the position of the vehicle for which a chalking record is to be created. Information about the position of the mobile device 124 may be communicated to web server 122 each time a stroke collection file is transmitted to web server 122. The following code may be utilized to calculate a distance between two GPS latitude and longitude values, and may be utilized in connection with the system 100. The following code is copyright 2009 Velosum, Inc.

| | |
|---|---|
| ′ | lat1, long1 = Latitude and Longitude of point 1 |
| | (in decimal degrees) |
| ′ | lat2, long2 = Latitude and Longitude of point 2 |
| | (in decimal degrees) |
| ′ | unit = the unit you desire for results where ′M’ is |
| | statute miles (default) |

| | |
|---|---|
| ′ | ‘K’ is kilometers |
| ′ | ‘N’ is nautical miles |
| ′ | ‘F’ is nautical miles |

Const pi = 3.1415926535897931
Function distance(ByVal lat1, ByVal lon1, ByVal lat2, ByVal lon2,
ByVal unit)

Dim theta, dist
theta = lon1 − lon2
dist = Sin(deg2rad(lat1)) * Sin(deg2rad(lat2)) + Cos(deg2rad(lat1)) *

Cos(deg2rad(lat2)) * Cos(deg2rad(theta))

| | |
|---|---|
| dist = acos(dist) | |
| dist = rad2deg(dist) | |
| distance = dist * 60 * 1.1515 | ′Statute Miles |
| Select Case UCase(unit) | |

| | |
|---|---|
| Case “K” | ′Kilometers |

distance = distance * 1.609344

| | |
|---|---|
| Case “N” | ′Nautical Miles |

distance = distance * 0.8684

| | |
|---|---|
| Case “F” | ′Feet |

distance = distance / 5280

End Select

End Function

| | |
|---|---|
| ′ | |
| ′ | This function get the arc cosine function from arc tangent function |
| ′ | |

Function acos(ByVal rad)

If Abs(rad) < > 1 Then

acos = pi / 2 − Atan(rad / Sqrt(1 − rad * rad))

ElseIf rad = −1 Then

acos = pi

End If

End Function
′
′This function converts decimal degrees to radians
′
Function deg2rad(ByVal Deg)

deg2rad = CDbl(Deg * pi / 180)

End Function
′
′This function converts radians to decimal degrees
′Function rad2deg(ByVal Rad)

rad2deg = CDbl(Rad * 180 / pi)

End Function

Certain municipalities may establish a minimum movement distance in order to avoid a parking zone time limit violation. For example, a particular municipality may require that a vehicle be moved at least 200 feet in order to avoid a parking zone time limit violation. If a first chalking record is created for a vehicle parked at a first location in a 30 minute parking zone is created, and then 35 minutes later a second chalking record is created for the same vehicle in a second location within 200 feet of the first location, the system may send a message to the PEO to issue a citation.

A status indicator may be shown on cellular phone 124 to indicate when a GPS signal is available and has been acquired. In one embodiment, the icon may be either red or green. A red icon indicates that a GPS signal has not been acquired, while a green icon indicates that a GPS signal has been acquired. The icon may appear on both an internal and external screen of certain cellular telephones having internal and external screens.

In certain embodiments, a camera (not shown) may also be used in connection with the system 100. Photographs taken by the camera may be transmitted to the web server 122 in a similar manner to input received from digital pen 110. The photographs may be used as evidence illustrating the violation (e.g. showing the violator's vehicle parked in a no parking zone), which may be used if a particular parking citation is challenged. In some embodiments, a photograph transmitted to web server 122 may be analyzed by character recognition software that is operable to extract a license plate from the image. Systems for performing such extraction include AutoVu™ license plate recognition software are available from Gentec, of Quebec, Canada. When combined with a GPS receiver, a chalking record may be created by simply taking a picture of the vehicle's license plate. The time, location, parking zone time limit, and vehicle license plate may all be determined automatically by the system 100.

FIG. 2 is a block diagram of a data structure for an example stroke collection file 200. In one embodiment, as a PEO makes a pen stroke on the form 112 using the digital pen 110, the digital pen 110 assigns a stroke order (e.g., first, second, third, etc.) to the stroke relative to previous pen strokes, if any, made on the form 112. After determining the coordinates (x(t), y(t)) of the stroke in relation to the position-coding pattern 114, the digital pen 110 adds the stroke order and stroke coordinates to the stroke collection file 200. When the PEO indicates that the form is complete (e.g., by marking a predetermined location on the form 112), the digital pen 110 transmits the stroke collection file 200 to the cellular phone 124 for further processing and transmission to the web server 122.

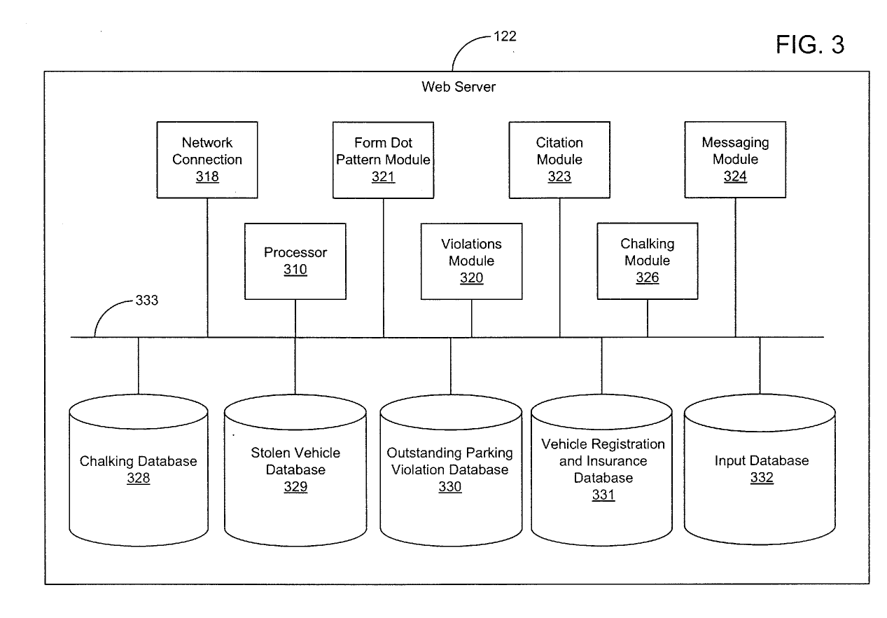

FIG. 3 is a block diagram of a web server 122 usable by the system 100 shown in FIG. 1. In one embodiment, the web server 122 includes a processor 310 for performing software instructions on data received from the digital pen 110, as described herein. The web server 122 includes a network connection 318 for communicating with the network 128 shown in FIG. 1. A bus 333 connects the processor 310, the network connection 318, modules 320, 321, 323, 324, 326, and databases 328, 329, 330, 331, 332. The illustrated modules 320, 321, 323, 324, 326 are executable on the processor. The illustrated databases 328, 329, 330, 331, 332 may be queried to provide requested information, and may be repositories for information that may be retrieved at a later time.

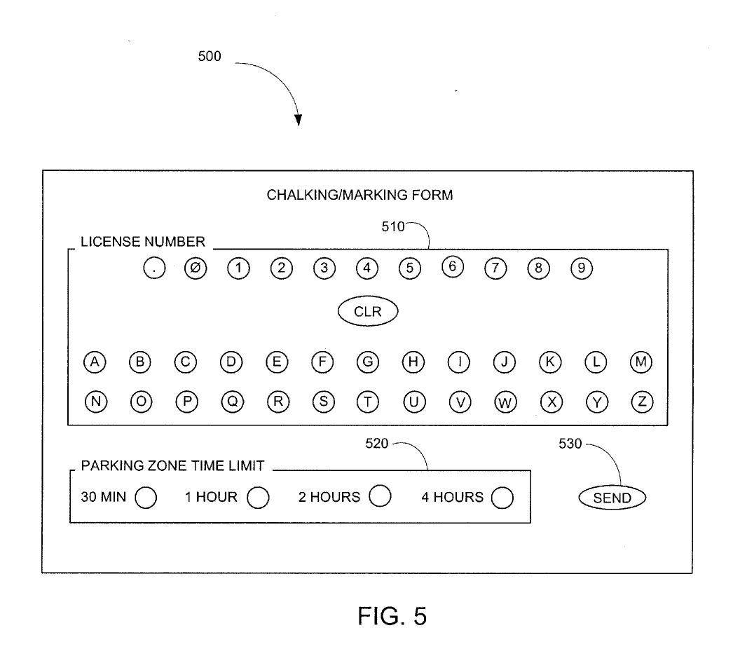

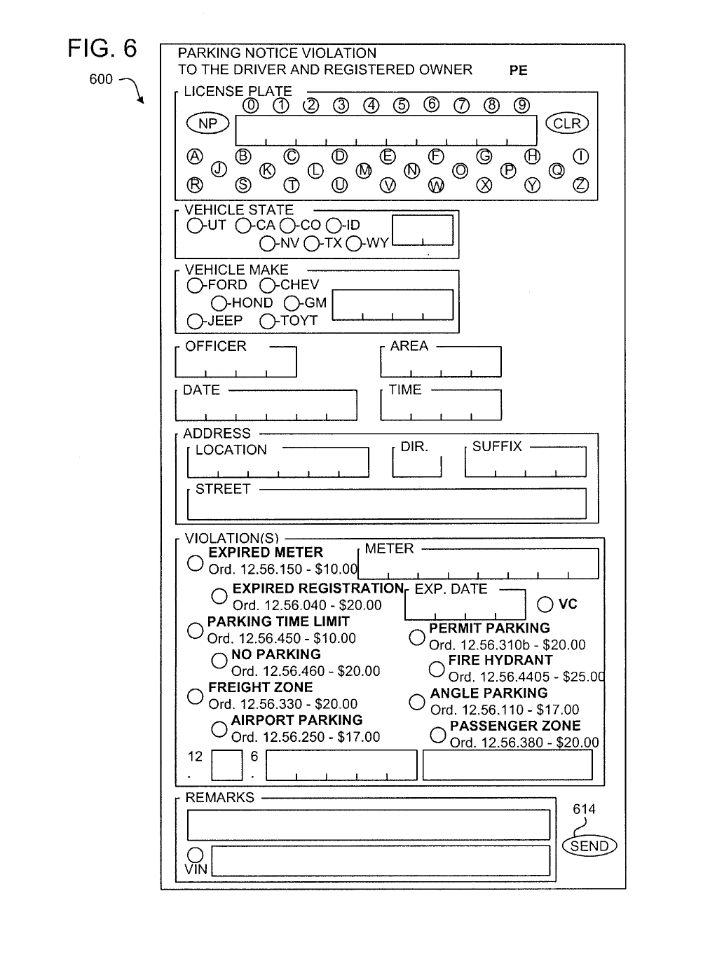

A form dot pattern module 321 is operable to determine the type of form represented by a particular form dot pattern. As discussed above, the form 112 shown in FIG. 1 includes a form dot pattern 114. For example, a chalking form 500 shown in FIG. 5 may have one dot pattern, while a citation form 600 shown in FIG. 6 may have another dot pattern. The form dot pattern 114 may be captured by the digital pen 110 and transmitted to the web server 122, where it may be processed to determine the type of form being used. Once the form dot pattern module 321 determines the appropriate type of form, the pen strokes contained in the stroke collection file may be associated with appropriate fields on the form.

A violations module 320 may be operable to compare an incoming input to a variety of databases containing information about various violations, including a stolen vehicle database 329, an outstanding parking violations database 330, and a vehicle registration and insurance database 331. The input from a pen may include a unique identifier of a vehicle, such as a license plate, VIN number, etc. The unique identifier may be checked against the various databases to determine whether any records are relevant to the vehicle. A message may be generating by messaging module 324 and communicated to a PEO if any relevant records are found. For example, a PEO may enter the license plate of a stolen vehicle while chalking. As a result, the PEO may receive a message from the messaging module 324 indicating that the vehicle is stolen and instructing the PEO to take appropriate action (e.g., notifying the police, towing the vehicle, immobilizing the vehicle, etc.). In another example, the insurance or the registration of a vehicle may have lapsed. After entering the vehicle's unique identifier, the PEO may receive a message from the messaging module 324 to issue a citation to the vehicle for the lapse in insurance or registration.

Messages from messaging module 324 may be delivered to a PEO in a variety of ways, including text messages, audio messages, visual messages, and tactile messages. Examples of text messages include messages sent via a webpage, an SMS message, an email message, and the like. In one embodiment, messages between cellular phone 124 and web server 122 are exchanged via the hypertext transfer protocol (HTTP). In response to input from the digital pen 110, the web server 122 may include instructions for the PEO in its response. Audio messages may likewise be sent by messaging module 324. For example, the messaging module 324 may cause a PEO's cellular phone to make a particular noise (e.g. beep twice) when the PEO is to take a certain action (e.g. issue a citation to the vehicle because the parking zone time limit has been exceeded). A PEO's cell phone 124 may flash or vibrate in order to communicate a message. Of course, any or all of the foregoing examples may be used in combination. For example, a text message may be accompanied by an audio message and vibration, thus alerting a PEO to a new message from messaging module 324.

A chalking module 326 may be operable to record chalking records in a chalking database 328, and to query the chalking database 328 to determine whether an active chalking record exists for a particular vehicle. When an active chalking record for the vehicle is available, the module may compare the time of the active chalking record to a new chalking record to determine whether a parking zone time limit violation has occurred. If a new chalking record is received, and an active chalking record for the same vehicle is not found in the chalking database 328, a new chalking record may be recorded.

The chalking database 328 may record various data associated with each chalking record, including a unique identifier of a vehicle (e.g. license plate, VIN number), the time of the chalking record, the location of the vehicle, and the parking zone time limit. As one of skill in the art will recognize, other information may also be recorded and stored in chalking database 328, including photographs of chalked vehicles. Records in the chalking database may be classified as active for a specified period of time. For example, a chalking record may be active for 24 hours, and inactive thereafter. Chalking records may be maintained in the chalking database 328 as inactive records for as long as is desired in order to maintain records and collect data.

In one embodiment, the chalking database 328 is implemented as an SQL database. The chalking database 328 may include the following tables and fields. The following is copyright 2009 Velosum, Inc.

| | |
|---|---|
| Field | Description |

Chalk Table

| | |
|---|---|
| ChalkKey | Autonumber key value of Chalk Event |
| CustKey | Customer ID |
| UserKey | User Identification Key |
| DeviceKey | Phone Device Key |
| ChalkZoneKey | Key Value of Chalking Zone for Customer |
| ChalkTypeKey | Key Value of Chalk Event Type |
| VehLicense | License Plate Number of Vehicle being |
| | Chalked or Citation Event |
| VehState | License State of Vehicle being Chalked |
| CreateDate | Timestamp of Chalking or Citation Event |
| Latitude | GPS Latitude |
| Longitude | GPS Longitude |
| Expired | Boolean (True/False) |

ChalkZone Table

| | |
|---|---|
| ChalkZoneKey | Autonumber of Chalking Zone for Customer |
| CustKey | Customer ID |
| ChalkZoneID | Description of Chalk Zone |
| Interval | Chalking Zone Limit in Minutes |

ChalkType Table

| | |
|---|---|
| ChalkTypeKey | Autonumber key value of Chalk Event Type |
| ChalkTypeID | Description of Chalk Event Type |

The following SQL creation queries may be utilized to create the SQL tables described above. The following is copyright 2009 Velosum, Inc.

```
CREATE TABLE [dbo].[Chalk](
  [ChalkKey] [int] IDENTITY(1,1) NOT NULL,
  [CustKey] [int] NOT NULL,
  [UserKey] [int] NOT NULL,
  [DeviceKey] [int] NOT NULL,
  [ChalkZoneKey] [int] NULL,
  [ChalkTypeKey] [int] NOT NULL,
  [VehLicense] [varchar](20) COLLATE
  SQL_Latin1_General_CP1_CI_AS NOT NULL,
  [VehState] [varchar](2) COLLATE
  SQL_Latin1_General_CP1_CI_AS NOT NULL
  [TimeStamp] [datetime] NOT NULL,
  [CreateDate] [datetime] NOT NULL
  CONSTRAINT DF_Chalk_CreateDate]
  DEFAULT (getdate( )),
  [Latitude] [decimal](15, 12) NULL,
  [Longitude] [decimal](15, 12) NULL,
  [Expired] [bit] NOT NULL
  CONSTRAINT [DF_Chalk_Expired] DEFAULT
  ((0))
)
CREATE TABLE [dbo].[ChalkType](
  [ChalkTypeKey] [int] NOT NULL,
  [ChalkTypeID] [varchar](20) COLLATE
  SQL_Latin1_General_CP1_CI_AS NOT NULL
)
CREATE TABLE [dbo].[ChalkZone](
  [ChalkZoneKey] [int] IDENTITY(1,1) NOT NULL,
  [CustKey] [int] NULL,
  [ChalkZoneID] [varchar](20) COLLATE
  SQL_Latin1_General_CP1_CI_AS NOT NULL,
  [Interval] [int] NOT NULL
)
```

A citation module 323 may be operable to record citations. Citations may be added to an outstanding parking violation database 330.

An input database 332 may be a repository of data received from the digital pen 110. The input database 332 may maintain stroke collection files and processed form data. In one embodiment, the input database 332 may maintain stroke collection files such that each citation that is issued may be reproduced. Using the appropriate stroke collection file stored in input database 332 and the appropriate form (e.g. a citation form), an electronic image of each citation may be reproduced.

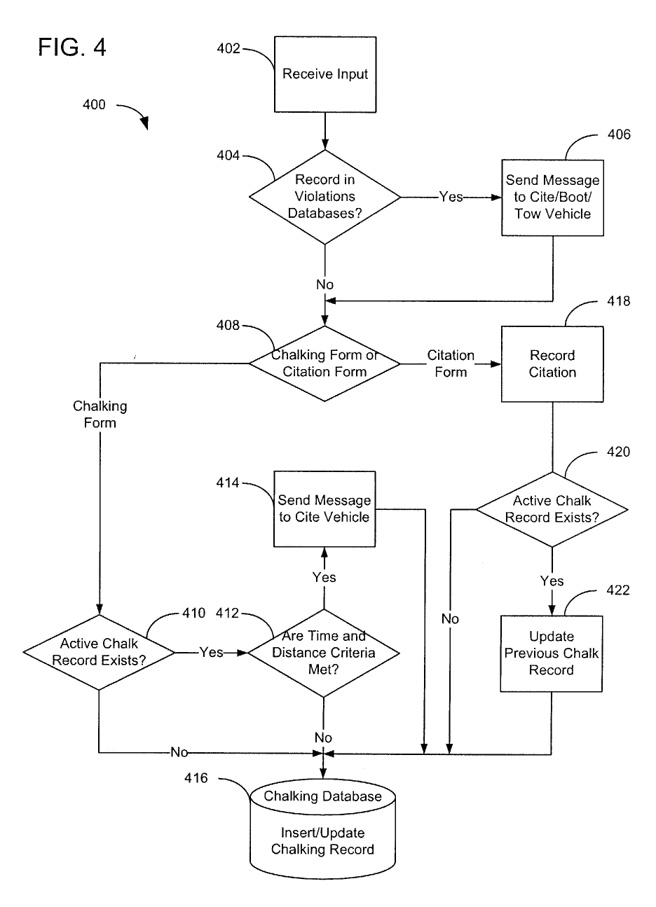

FIG. 4 is a flow chart illustrating one embodiment of a process 400 for receiving input from the digital pen 110 shown in FIG. 1. At step 402, input is received. The received input includes a unique identifier of a vehicle. At step 404, violations databases (e.g. databases 329, 330, 331 shown in FIG. 3) are queried using the unique identifier. If relevant records are returned by the query, at step 406 a message is sent to issue a ticket, boot (immobilize), or tow the vehicle.

At step 408, the type of form associated with the input is determined. If the form is a chalking form, the process proceeds to step 410. At step 410, the chalking database is queried to determine whether an active chalking record exists corresponding to the unique identifier. If an active chalking record does not exist, the process proceeds to insert a record in the chalking database 416. If an active chalking record exists, time and distance criteria are evaluated at step 412. If the time and distance criteria are met, a message is sent to issue a citation 414. After sending the message to issue a citation 414, the chalking record for the vehicle is updated. In this way, a second time offender may receive an additional citation without double-pass chalking. If the time and distance criteria are not met, the chalking record is updated 416.

When an input corresponds to a citation form, the process proceeds from step 408 to step 418. At step 418, the citation is recorded. At step 420, it is determined whether an active chalking record exists. If not, a chalking record is inserted into chalking database 416. If a chalking record does exist, the chalking record is updated at step 422.

By way of example, FIG. 5 graphically illustrates one embodiment of a chalking form. A PEO may record the license plates of vehicles within a zone by marking the letters and numbers constituting the license plate in a license plate section 510 on the chalking form 500. The PEO may also indicate the parking zone time limit in section 520. As discussed above, in certain embodiments, a parking zone time limit may be determined based on position information derived from GPS or RFID location information. In such embodiments, it may not be necessary for the PEO to indicate the parking zone time limit. Once a chalking form 500 has been completed, the PEO may mark the send button 530 in order to transmit a stroke collection file corresponding to a chalking record to the web server 122 shown in FIG. 1. The chalking form 500 may be laminated so that it may be used repeatedly. In certain embodiments, the digital pen 110 shown in FIG. 1 may be able to operate in a mode where pen strokes are electronically captured, but an ink mark is not left on a paper form. Accordingly, the chalking form 500 may be utilized repeatedly.

By way of example, FIG. 6 graphically illustrates a parking citation 600 (Parking Notice Violation to the Driver and Registered Owner) with various fields where a PEO may write information to complete the citation. When the PEO is finished writing information on the parking ticket 600, the PEO may write a pen stroke in or through a send field 614, which instructs the digital pen to send the data it has collected to the user's cellular phone or other communication device. The user who wrote the ticket 600 may then leave the paper copy of the parking citation 600 on a vehicle's windshield. The data collected by the digital pen may be sent to and automatically processed by a central web server

Those having skill in the art will recognize that many changes may be made to the details of the above-described embodiments without departing from the underlying principles of the present disclosure. The scope of the present invention should, therefore, be determined only by the following claims.

1. A system for determining a parking violation comprising:
a mobile communication device;
a digital pen configured to write pen strokes on a paper form and to store corresponding stroke coordinates in a first stroke collection file, and to transmit the first stroke collection file using the mobile communication device; and
a server comprising:
a processor;
a data connection operable to send data to and receive data from the mobile communication device;
a chalking database;
a chalking module executable on the processor and configured to:
receive the first stroke collection file at a first time comprising data corresponding to a plurality of pen strokes written on a paper form using the digital pen, the plurality of pen strokes comprising a unique identifier of a first vehicle;
receive a location of the first vehicle;
receive a parking zone time limit associated with the location of the first vehicle; and
enter a first chalking record into the chalking database, the first chalking record consisting of the unique identifier of the first vehicle, the location of the first vehicle, and the first time;
wherein the first chalking record is usable by the chalking module to determine whether the first vehicle has exceeded the parking zone time limit.

2. The system of claim 1, further comprising:
a messaging module executable on the processor and configured to send messages to the mobile communication device; and
wherein the chalking module is further configured to:
receive a second stroke collection file at a second time corresponding to a plurality of pen strokes written on a paper form using the digital pen, the plurality of pen strokes comprising the unique identifier of the first vehicle;
query the chalking database using the unique identifier of the first vehicle to determine that the unique identifier of the first vehicle corresponds to the first chalking record;
determine that a time difference between the first time and the second time exceeds the parking zone time limit associated with the first location;
to cause the messaging module to send a message to issue a citation to the first vehicle.

3. The system of claim 2, wherein the chalking module is further configured to:
enter a second chalking record into the chalking database, the second chalking record comprising the unique identifier of the first vehicle, the location of the first vehicle, and the second time.

4. The system of claim 1, wherein the chalking module is further configured to:
receive a third stroke collection file at a third time comprising data corresponding to a plurality of pen strokes written on a paper form using the digital pen, the plurality of pen strokes comprising a unique identifier of a second vehicle;
receive a location of the second vehicle;
receive a parking zone time limit associated with the location of the second vehicle;
query the chalking database using the unique identifier of the second vehicle to determine that the unique identifier of the second vehicle does not correspond to an existing chalking record;
enter a second chalking record into the chalking database, the second chalking record consisting of the unique identifier of the second vehicle, the location of the second vehicle, and the second time.

5. The system of claim 1, further comprising:
a Global Positioning System (GPS) receiver, the GPS receiver operable to determine the location of the first vehicle, and to transmit the location of the first vehicle to the mobile communication device.

6. The system of claim 1, further comprising:
a radio frequency identification (RFID) tag reader operable to determine the location of the first vehicle from an RFID tag located in proximity to the first vehicle, and to transmit the location of the first vehicle to the mobile communication device.

7. The system of claim 1, further comprising:
a messaging module executable on the processor and configured to send messages to the mobile communication device; and
an outstanding parking citation database;
wherein the chalking module is further configured to query the outstanding parking citation database using the unique identifier of the first vehicle to determine that the unique identifier of the first vehicle corresponds to a record in the outstanding parking violation database; and
wherein the chalking module is further configured to cause the messaging module to take an action selected from the group consisting of issuing a citation, immobilizing the vehicle, and towing the vehicle.

8. The system of claim 1, further comprising:
a form dot pattern module executable on the processor and configured to:
receive a form dot pattern associated with a dot pattern on the paper form, the form dot pattern configured to indicate a type of form; and
determine the type of form represented by the form dot pattern.

9. The system of claim 1, further comprising:
a parking zone time limit database;
wherein the chalking module is further configured to query the parking zone time limit database using the location of the first vehicle and to receive in response to the query the parking zone time limit associated with the location of the first vehicle.

10. A method for determining a parking violation, the method comprising:
receiving a first stroke collection file at a first time comprising data corresponding to a plurality of pen strokes written on a paper form using a digital pen, the plurality of pen strokes representing a unique identifier of a first vehicle;
receiving a location of the first vehicle;
receiving a parking zone time limit associated with the location of the first vehicle;
entering a first chalking record into a chalking database, the first chalking record comprising the unique identifier of the first vehicle, the location of the first vehicle, and the first time; and
using the first chalking record to determine whether the first vehicle has exceeded the parking zone time limit.

11. The method of claim 10, wherein using the first chalking record comprises:
receiving a second stroke collection file at a second time corresponding to a plurality of pen strokes written on a paper form using the digital pen, the plurality of pen strokes comprising the unique identifier of the first vehicle;
querying the chalking database using the unique identifier of the first vehicle to determine that the unique identifier of the first vehicle corresponds to the first chalking record;
determining that a time difference between the first time and the second time exceeds the parking zone time limit associated with the first location;
sending an instruction to issue a citation to the first vehicle.

12. The method of claim 11, further comprising:
entering a second chalking record into the chalking database, the second chalking record comprising the unique identifier of the first vehicle, the location of the first vehicle, and the second time.

13. The method of claim 10, further comprising:
receiving a third stroke collection file at a third time comprising data corresponding to a plurality of pen strokes written on a paper form using the digital pen, the plurality of pen strokes comprising a unique identifier of a second vehicle;
receiving a location of the second vehicle;
receiving a parking zone time limit associated with the location of the second vehicle;
querying the chalking database using the unique identifier of the second vehicle to determine that the unique identifier of the second vehicle does not correspond to an existing chalking record;
entering a second chalking record into the chalking database, the second chalking record consisting of the unique identifier of the second vehicle, the location of the second vehicle, and the second time.

14. The method of claim 10, wherein the step of receiving a location of the first vehicle comprises receiving Global Positioning System (GPS) information.

15. The method of claim 10, wherein the step of receiving a location of the first vehicle comprises receiving position information from an RFID tag located in proximity to the first vehicle.

16. The method of claim 10, further comprising:
querying an outstanding parking violation database using the unique identifier of the first vehicle to determine that the unique identifier of the first vehicle corresponds to a record in the outstanding parking violation database;
sending an instruction to take an action selected from the group consisting of issuing a citation, immobilizing the vehicle, and towing the vehicle.

17. The method of claim 10, further comprising:
receiving a form dot pattern associated with a dot pattern on the paper form, the form dot pattern configured to indicate a type of form.

18. The method of claim 17, further comprising:
determining that the form dot pattern represents a chalking form.

19. The method of claim 17, further comprising:
determining that the form dot pattern represents a citation form.

20. The method of claim 10, wherein receiving a parking zone time limit associated with the location of the first vehicle further comprises querying a parking zone time limit database using the location of the first vehicle and receiving in response to the query the parking zone time limit associated with the location of the first vehicle.

21. A computer readable medium comprising computer executable instructions for performing a method for determining a parking violation, the method comprising:
receiving a first stroke collection file at a first time comprising data corresponding to a plurality of pen strokes written on a paper form using a digital pen, the plurality of pen strokes representing a unique identifier of a first vehicle;
receiving a location of the first vehicle;
receiving a parking zone time limit associated with the location of the first vehicle; and
entering a first chalking record into a chalking database, the first chalking record comprising the unique identifier of the first vehicle, the location of the first vehicle, and the first time;
wherein the first chalking record is usable to determine whether the first vehicle has exceeded the parking zone time limit.

22. The computer readable storage medium of claim 21, wherein the method further comprises:
receiving a second stroke collection file at a second time corresponding to a plurality of pen strokes written on a paper form using the digital pen, the plurality of pen strokes comprising the unique identifier of the first vehicle;
querying the chalking database using the unique identifier of the first vehicle to determine that the unique identifier of the first vehicle corresponds to the first chalking record;
determining that a time difference between the first time and the second time exceeds the parking zone time limit associated with the first location;
sending an instruction to issue a citation to the first vehicle.

23. The computer readable storage medium of claim 22, wherein the method further comprises:
entering a second chalking record into the chalking database, the second chalking record comprising the unique identifier of the first vehicle, the location of the first vehicle, and the second time.

24. The computer readable storage medium of claim 21, wherein the method further comprises:
receiving a third stroke collection file at a third time comprising data corresponding to a plurality of pen strokes written on a paper form using the digital pen, the plurality of pen strokes comprising a unique identifier of a second vehicle;
receiving a location of the second vehicle;
receiving a parking zone time limit associated with the location of the second vehicle;
querying the chalking database using the unique identifier of the second vehicle to determine that the unique identifier of the second vehicle does not correspond to an existing chalking record;
entering a second chalking record into the chalking database, the second chalking record consisting of the unique identifier of the second vehicle, the location of the second vehicle, and the second time.

25. The computer readable storage medium of claim 21, wherein the step of receiving a location of the first vehicle comprises receiving Global Positioning System (GPS) information.

26. The computer readable storage medium of claim 21, wherein the step of receiving a location of the first vehicle comprises receiving position information from an RFID tag located in proximity to the first vehicle.

27. The computer readable storage medium of claim 21, wherein the method further comprises:
querying an outstanding parking violation database using the unique identifier of the first vehicle to determine that the unique identifier of the first vehicle corresponds to a record in the outstanding parking violation database;
sending an instruction to take an action selected from the group consisting of issuing a citation, immobilizing the vehicle, and towing the vehicle.

28. The computer readable storage medium of claim 21, wherein the method further comprises:
receiving a form dot pattern associated with a dot pattern on the paper form, the form dot pattern configured to indicate a type of form.

29. The computer readable storage medium of claim 21, wherein the method further comprises:
determining that the form dot pattern represents a chalking form.

30. The computer readable storage medium of claim 21, wherein the method further comprises:
determining that the form dot pattern represents a citation form.

31. The computer readable storage medium of claim 21, wherein receiving a parking zone time limit associated with the location of the first vehicle further comprises querying a parking zone time limit database using the location of the first vehicle and receiving in response to the query the parking zone time limit associated with the location of the first vehicle.

32. A system for determining a parking violation, the system comprising:
means for receiving a first stroke collection file at a first time comprising data corresponding to a plurality of pen strokes written on a paper form using a digital pen, the plurality of pen strokes representing a unique identifier of a first vehicle;
means for receiving a location of the first vehicle;
means for receiving a parking zone time limit associated with the location of the first vehicle; and
means for entering a first chalking record into a chalking database, the first chalking record comprising the unique identifier of the first vehicle, the location of the first vehicle, and the first time; and
means for determining whether the first vehicle has exceeded the parking zone time limit based on the first chalking record.
